(19) United States
(12) Patent Application Publication
(10) Pub. No.: US 2019/0255917 A1
(43) Pub. Date: Aug. 22, 2019

(54) WINDOW CONTROL DEVICE

(71) Applicant: KABUSHIKI KAISHA TOKAI RIKA DENKI SEISAKUSHO, Aichi (JP)

(72) Inventor: Ryoko NAKANO, Aichi (JP)

(21) Appl. No.: 16/344,209

(22) PCT Filed: Oct. 18, 2017
(86) PCT No.: PCT/JP2017/037669

§ 371 Date: Apr. 23, 2019

(30) Foreign Application Priority Data
Oct. 24, 2016 (JP) 2016-207836

(51) Int. Cl. B60J 1/17; E05B 81/64; E05F 15/60; B60R 16/02

(52) U.S. Cl. CPC B60J 1/17; E05B 81/64; E05Y 2900/55; B60R 16/02; E05F 15/60

(57) ABSTRACT

A window control device includes sensor sections, the number of the sensor sections being not less than the number of windows to be opened and closed on a vehicle and the sensor sections having N (wherein N is an integer of two or more) sensor modules disposed on a door trim of the vehicle, and a controller configured to, when the sensor sections detect a specified operation, which is an operation specified in advance, control a window specified according to the specified operation such that the window is driven in a drive mode corresponding to the specified operation.

### CROSS REFERENCE TO RELATED APPLICATIONS

The present application claims the priority of Japanese patent application No. 2016-207836, and the entire contents of Japanese patent application No. 2016-207836 are incorporated herein by reference.

### TECHNICAL FIELD

The present invention relates to a window control device.

### BACKGROUND ART

A window control device is known which includes a control panel configured to operate a (pane of) window glass by recognizing control input resulting from a touch (for example, refer to Patent Document 1).

This window control device can operate a plurality of panes of window glass, and an image display unit displays information of one window glass to be operated in the plurality of panes of window glass, the display on the image display unit being changed from the information of the one window glass to information of another window glass, the window glass to be operated being changed from the one window glass to another window glass by moving an operating tool to bring it into contact with a control panel and thereafter moving the operating tool away from the control panel, while moving the operating tool at a predetermined speed or faster along a second direction following a main plane of the control panel. The display on the image display unit is switched from the information of the one window glass to the information of another window glass and the window glass to be operated is changed from the one window glass to another window glass by performing a so-called flick operation; and therefore, an erroneous operation can be prevented by visually grasping the window glass to be operated. Then, the window glass can be operated by the user touching the control panel with the tip of his or her finger, and this enables the window glass to be operated by the simple operation, whereby the operability of the window glass control device can be improved.

### CITATION LIST

### Patent Document

Patent Document 1: JP 2015-17360A

### SUMMARY OF INVENTION

### Technical Problem

In the window control device of Patent Document 1, the window glass to be operated is changed by performing the so-called flick operation. A switching operation needs to be performed to switch target windows to be opened or closed, and an opening or closing operation needs to be performed on the switched target window to be opened or closed. This causes a problem in that the window control operation takes some time and effort.

An object of the invention is to provide a window control device enabling a smooth operation such as in opening or closing a window.

### Solution to Problem

The invention provides a window control device characterized under [1] to [12] below.

[1] A window control device including the number of sensor sections equal to or greater than the number of windows to be opened and closed on a vehicle, the sensor sections having N (N is an integer of two or greater) sensor modules disposed on a door trim of the vehicle, and a controller configured to control, when the sensor sections detect a specified operation, which is an operation specified in advance, to control a window that is set according to the specified operation to be driven in a drive mode corresponding to the specified operation.

[2] The window control device according [1] above,

wherein the specified operation is an upward moving operation on the sensor section, and the drive mode is a drive mode in a closing direction of the window.

[3] The window control device according to [1] or [2] above,

wherein the specified operation is a downward moving operation on the sensor section, and the drive mode is a drive mode in an opening direction of the window.

[4] The window control device according to [2] above,

wherein the specified operation is a moving operation taking a form of an upward flick operation on the sensor section, and the drive mode is a drive mode in which the window is fully closed.

[5] The window control device according to [3] above,

wherein the specified operation is a moving operation taking a form of a downward flick operation on the sensor section, and the drive mode is a drive mode in which the window is fully opened.

[6] The window control device according to [2] above,

wherein the specified operation is a moving operation taking a form of an upward tracing operation on the sensor section, and the drive mode is a drive mode in which a window glass of the window is driven in a closing direction by an amount corresponding to a traveling amount in the tracing operation.

[7] The window control device according to [3] above,

wherein the specified operation is a moving operation taking a form of a downward tracing operation on the sensor section, and the drive mode is a drive mode in which the window glass of the window is driven in an opening direction by an amount corresponding to a traveling amount in the tracing operation.

[8] The window control device according to any one of [1] to [7] above,

wherein the sensor sections are disposed individually on a first wall surface of a door pocket of the vehicle on a side of the door packet situated closer to a driver seat and a second wall surface on a passenger compartment side of the door trim, the second wall surface facing the first wall surface of the door pocket across a door handle.

[9] The window control device according to [8] above,

wherein the specified operation is an upward moving operation on both of the sensor sections provided individually on the first and second wall surfaces, and the drive mode is a drive mode in the closing direction of both of the windows on a driver seat side and a front passenger seat side.

[10] The window control device according to [8] or [9] above,

wherein the specified operation is a downward moving operation on both of the sensor sections provided individually on the first and second wall surfaces, and the drive mode is a drive mode in the opening direction of both of the windows on the driver seat side and the front passenger seat side.

[11] The window control device according to any one of [8] to [10] above,

wherein the specified operation is a moving operation on both of the sensor sections provided individually on the first and second wall surfaces in an overall length direction of the vehicle, and the drive mode is a drive mode of locking or unlocking.

[12] The window control device according to any one of [1] to [11] above,

wherein the sensor sections are disposed on a third plane opened toward an interior of the passenger compartment, the third plane being contiguous with the first wall surface of the door pocket on the side of the door pocket situated closer to the driver seat and the second wall surface on the passenger compartment side of the door trim, the second wall surface facing the first wall surface of the door pocket across a door handle, and
wherein the specified operation is a moving operation on the sensor sections in the overall length direction of the vehicle, and the drive mode is a mode in which an emission of light from a separately provided light emitter is controlled.

### Advantageous Effects of Invention

According to the embodiment of the invention, the window control device can be provided which enables the smooth operation in opening or closing the window.

### BRIEF DESCRIPTION OF DRAWINGS

FIG. 1 is a perspective view of a door of a vehicle on which a window control device according to a first embodiment is mounted.

FIG. 2 is a front view illustrating touch sensors of the window control device according to the first embodiment.

FIG. 3 is a block diagram illustrating the configuration of the window control device according to the first embodiment.

FIG. 4 is a flowchart illustrating operations of the window control device according to the first embodiment.

FIG. 5A is a perspective view illustrating an operation example of a front side window in the window control device.

FIG. 5B is a perspective view illustrating an operation example of a rear side window in the window control device.

FIG. 6 is a perspective view of a door of a vehicle on which a window control device according to a second embodiment is mounted.

FIG. 7 is a block diagram illustrating the configuration of a window control device according to the second embodiment.

FIG. 8A is a perspective view illustrating an operation example of a window in the window control device according to the second embodiment.

FIG. 8B is a perspective view illustrating an operation example of a front passenger seat window in the window control device according to the second embodiment.

FIG. 8C is a perspective view illustrating an operation example of a rear side window on a driver seat side in the window control device according to the second embodiment.

FIG. 8D is a perspective view illustrating an operation example of a rear side window on a front passenger seat side in the window control device according to the second embodiment.

FIG. 8E is a perspective view illustrating an operation example of the driver seat window and the front passenger seat window in the window control device according to the second embodiment.

FIG. 8F is a perspective view illustrating an operation example of the rear side window on the driver seat side and the rear side window on the front passenger seat side in the window control device according to the second embodiment.

FIG. 8G is a perspective view illustrating examples of locking and unlocking operations in the window control device according to the second embodiment.

FIG. 8H is a perspective view illustrating an example of a luminous intensity control operation of a light emitter in the window control device according to the second embodiment.

### DESCRIPTION OF EMBODIMENT

### First Embodiment

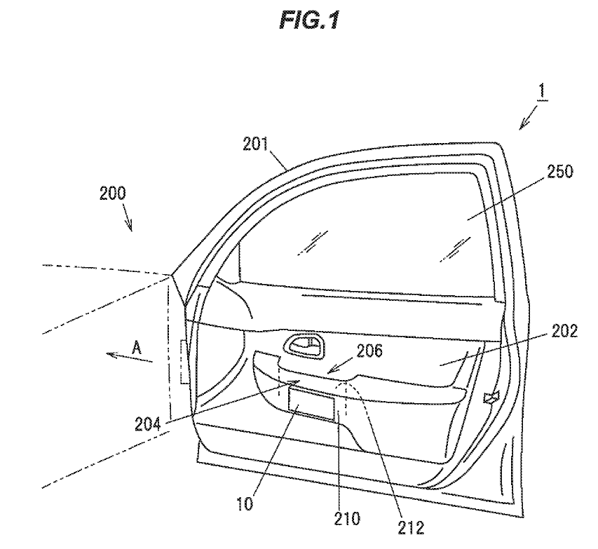

As illustrated in FIGS. 1 to 3, in a window control device 1 of a first embodiment, only one touch sensor including eight (N=8) sensor modules is provided on a wall surface of a door pocket which is situated closer to a driver seat. The window control device 1 includes one touch sensor 10 including two sensor sections 10a, 10b as an example of a number which is equal to or greater than the number of windows (a driver seat window, a rear side window on a driver seat side) to be opened and closed.

The window control device 1 according to the embodiment has the number of sensor sections equal to or greater than the number of windows to be opened and closed on a vehicle, the sensor sections having N (N is an integer of two or greater) sensor modules disposed on a door trim of the vehicle, a controller configured to control, when the sensor sections detect a specified operation, which is an operation specified in advance, to control a window that is set according to the specified operation to be driven in a drive mode corresponding to the specified operation.

As illustrated in FIG. 1, the door trim 202, which is an interior part of a door 201 (a driver seat side door) of a vehicle 200, is provided on a passenger compartment side of the door 201. A door handle 204 is provided on the door trim 202, and this door trim 202 is formed to project toward a driver seat for use by a driver when opening or closing the door. A recess portion or a hole portion, which is large enough for an operator to put in his or her fingers, is provided between the door trim 202 and the door handle 204 as a door pocket 206. For example, the operator opens or closes the door 201 by putting his or her fingers in the door pocket 206 to grip on the door handle 204.

As illustrated in FIG. 1, the touch sensor 10 is provided on an outer wall surface 210 which is a wall surface of the door pocket 206 situated on a side closer to the driver seat and constituting a part of the door trim 202.

### (Touch Sensor 10)

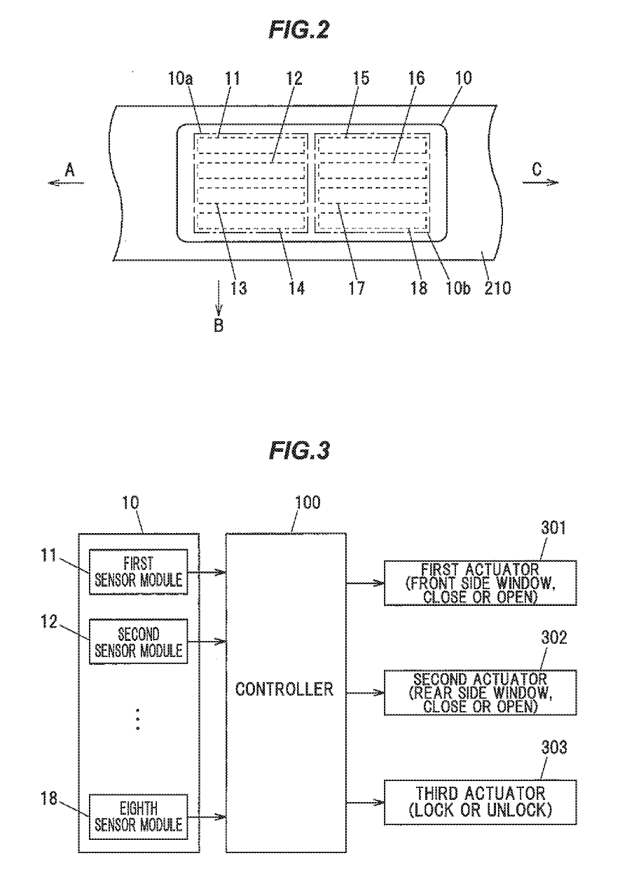

In this embodiment, the touch sensor 10 has eight (N=8) sensor modules 11, 12, . . . , 18 which are arranged as illustrated in FIG. 2. The touch sensor 10 having these sensor modules 11, 12, . . . , 18 is formed into, for example, a sheet-like shape and is mounted on the door trim 202. In FIG. 1, the touch sensor 10 is attached to the outer wall surface 210 which is the wall surface of the door pocket 206 situated on the side closer to the driver seat as an example of a position where the driver easily manipulates the touch sensor 10.

The touch sensor 10 should be a sensor which can detect whether the operator touches any of the sensor modules and various types of sensors such as an electrostatic sensor, a pressure sensor, and the like. In this embodiment, an electrostatic sensor is described as being used as the touch sensor 10.

The touch sensor 10 has eight (N=8) sensor modules 11, 12, . . . , 18 which are arranged into two columns of four sensor modules or 4×2 columns as illustrated in FIG. 2, and these sensor modules are detection electrodes configured to detect a touch or an approach of a finger or fingers of the operator. The individual sensor modules 11, 12, . . . , 18 are configured as independent electrodes and detect a change in electrostatic capacity value to detect a touch or an approach of the finger or fingers of the operator by forming a capacitor between the finger or fingers of the operator and the sensor modules themselves. To improve its detection sensitivity, the touch sensor 10 is preferably configured as a self-capacitive electrostatic capacity sensor.

The sensor sections constitute areas where the touch sensor is configured to detect a tracing operation or a flick operation as a moving operation of a part of a human body and areas where N electrodes are provided. In this embodiment, an area where 4×1 column of detection electrodes made up of the sensor modules 11, 12, 13, 14 are arranged corresponds to the sensor section 10a. In addition, an area where 4×1 column of detection electrodes made up of the sensor modules 15, 16, 17, 18 are arranged corresponds to the sensor section 10b.

In the window control device 1 according to the first embodiment, as illustrated in FIG. 3, the touch sensor 10 is connected to a controller 100. Inputs from the sensor modules 11, 12, . . . , 18 of the touch sensor 10 are inputted in parallel into the controller 100 through separate eight channels. A first actuator 301 and a second actuator 302 for window regulators for window control are connected to the controller 100. A third actuator 303 is connected to the controller 100 for a locking or an unlocking operation.

The first actuator 301 and the second actuator 302 are, for example, rotating motors for the window regulators, and windows are controlled to be opened or closed by rotating them forward or backward.

The third actuator 303 is, for example, an actuator such as a solenoid or a motor for locking and unlocking doors; or for locking and unlocking an opening and closing control of a window or windows. The doors can be locked and unlocked; or the opening and closing control of a window or windows can be executed by controlling the driving direction of the solenoid or the motor.

### Controller 100

The controller 100 is, for example, a microcomputer including a Central Processing Unit (CPU) configured to compute and process acquired data according to stored programs, and a Random-Access Memory (RAM) and a Read-Only Memory (ROM) which are of a semiconductor memory. A program for operating the controller 100, a threshold for determination of a touch and the like are stored in the ROM. The RAM is used as a storage region that temporarily stores computation results and the like, for example.

The controller 100 acquires signals from the sensor modules 11, 12, . . . , 18 which are arranged as illustrated in FIG. 2 to detect whether the individual sensor modules are touched. The controller 100 can detect whether the individual sensor modules are touched based on the threshold for determination of a touch. The controller 100 can detect the position of the sensor module that the operator touches and the direction of a moving operation (a tracing operation) performed by the operator by detecting the position of the sensor module that is determined to be touched in time series.

For example, in FIG. 2, when the controller 100 detects a touch from the sensor module 11 to the sensor module 14, the controller 100 can determine that a moving operation (a tracing operation) has performed on the sensor modules on a front side of the vehicle (A direction) in a downward direction (B direction).

In FIG. 2, when the controller 100 detects a touch from the sensor module 15 to the sensor module 18, the controller 100 can determine that a moving operation (a tracing operation) has performed on the sensor modules on a rear side of the vehicle (C direction) in the downward direction.

In FIG. 2, when the controller 100 detects a touch from the sensor module 14 to the sensor module 11, the controller 100 can determine that a moving operation (a tracing operation) has performed on the sensor modules on the front side of the vehicle (A direction) in an upward direction.

In FIG. 2, when the controller 100 detects a touch from the sensor module 18 to the sensor module 15, the controller 100 can determine that a moving operation (a tracing operation) has performed on the sensor modules on the rear side of the vehicle (C direction) in the upward direction.

In FIG. 2, when the controller 100 detects a touch from the sensor module 11 to the sensor module 15, the controller 100 can determine that a moving operation (a tracing operation) has performed on the sensor modules in the rear direction (C direction) in an overall length direction of the vehicle. In this embodiment, when the controller 100 detects a touch from the sensor module 12 to the sensor module 16; from the sensor module 13 to the sensor module 17; or from the sensor module 14 to the sensor module 18, the controller 100 can determine that a moving operation (a tracing operation) has performed on the sensor modules in the rear direction (C direction) in the overall length direction of the vehicle.

In FIG. 2, when the controller 100 detects a touch from the sensor module 15 to the sensor module 11, the controller 100 can determine that a moving operation (a tracing operation) has performed on the sensor modules in the front direction (A direction) in the overall length direction of the vehicle. In this embodiment, when the controller 100 detects a touch from the sensor module 16 to the sensor module 12; from the sensor module 17 to the sensor module 13; or from the sensor module 18 to the sensor module 14, likewise, the controller 100 can determine that a moving operation (a tracing operation) has performed on the sensor modules in the front direction (A direction) in the overall length direction of the vehicle.

The arrangement of the sensor modules of 4×2 columns described above constitutes an example of an arrangement of the sensor modules; and thus, any other arrangements can be adopted, provided that moving operations (tracing operations) in the upward and downward directions and in the overall length directions of the vehicle can be detected.

(Operations of Window Control Device according to First Embodiment)

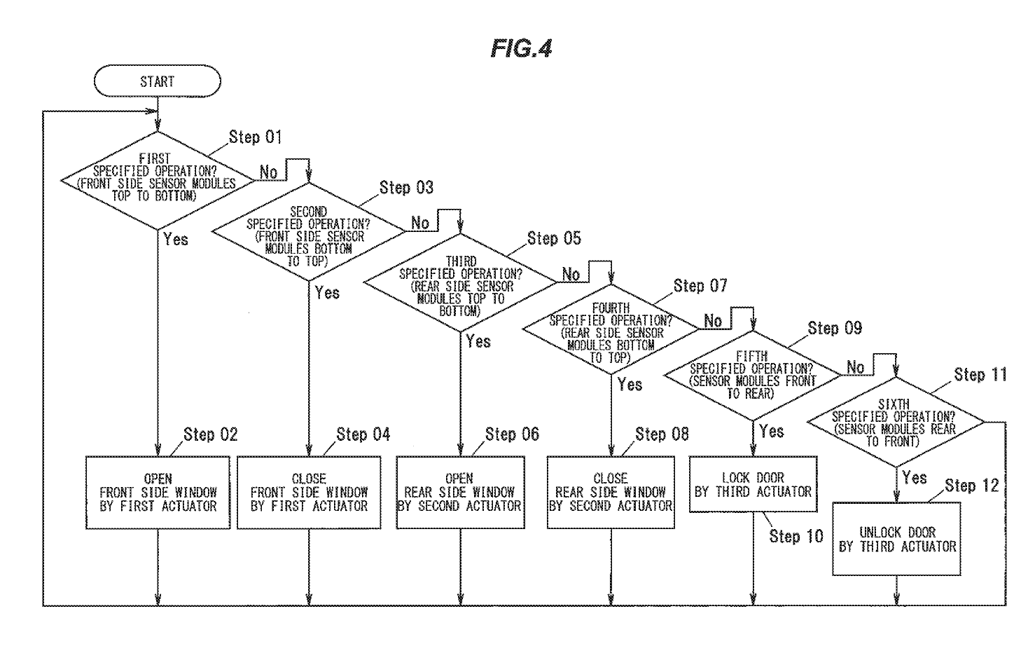

Operations of the window control device according to the first embodiment will be described based on a flow chart illustrated in FIG. 4.

In the first embodiment, a first specified operation is a moving operation (a tracing operation) in which the sensor modules on the front side of the vehicle (A direction) are touched from a top to a bottom. A second specified operation is a moving operation (a tracing operation) in which the sensor modules on the front side of the vehicle (A direction) are touched from the bottom to the top. A third specified operation is a moving operation (a tracing operation) in which the sensor modules on the rear side of the vehicle (C direction) are touched from the top to the bottom. A fourth specified operation is a moving operation (a tracing operation) in which the sensor modules on the rear side of the vehicle (C direction) are touched from the bottom to the top. A fifth specified operation is a moving operation (a tracing operation) in which the sensor modules are touched in the front direction (A direction) in the overall length direction of the vehicle. A sixth specified operation is a moving operation (a tracing operation) in which the sensor modules are touched in the front direction (A direction) in the overall length direction of the vehicle.

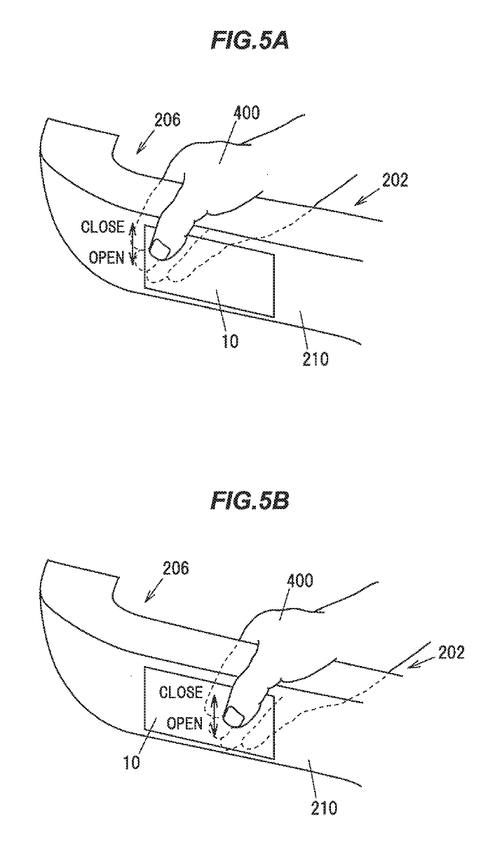

The controller 100 determines whether the first specified operation has been performed based on the results of detection of a moving operation (a tracing operation) by the touch sensor 10 (Step 01). As illustrated in FIG. 5A, the controller 100 determines whether a moving operation (a tracing operation) by a finger 400 has been performed on the sensor modules on the front side (A direction) of the touch sensor 10 in the downward direction. If the controller 100 determines that the first specified operation has been performed, the controller 100 proceeds to Step 02 (Step 01: Yes), whereas if the controller 100 determines that the first specified operation has not been performed, the controller 100 proceeds to Step 03 (Step 01: No). The controller 100 determines whether the first specified operation has been performed based on the results of the detection of the moving operation (the tracing operation) by the touch sensor 10.

The controller 100 drives the first actuator 301 to drive a window glass of a front side window 250 in an opening direction as a drive mode corresponding to the first specified operation (Step 02). For example, if the touch sensor 10 detects a flick operation as a moving operation from the top to the bottom, the controller 100 drives the window glass to fully open the front side window 250. In addition, if the touch sensor 10 detects a tracing operation, the controller 100 drives the window glass of the front side window 250 in an opening direction according to a traveling amount of the finger in the tracking operation. The controller 100 returns to Step 01 after it has driven the window glass of the front side window 250 in the opening direction and can execute the operation of the window control device according to the first embodiment repeatedly.

The controller 100 determines whether the second specified operation has been performed based on the results of detection of a moving operation (a tracing operation) by the touch sensor 10 (Step 03). As illustrated in FIG. 5A, the controller 100 determines whether a moving operation (a tracing operation) by the finger 400 has been performed on the sensor modules on the front side (A direction) of the touch sensor 10 in the upward direction. If the controller 100 determines that the second specified operation has been performed, the controller 100 proceeds to Step 04 (Step 03: Yes), whereas if the controller 100 determines that the second specified operation has not been performed, the controller 100 proceeds to Step 05 (Step 03: No).

The controller 100 drives the first actuator 301 to drive the window glass of the front side window 250 in a closing direction as a drive mode corresponding to the second specified operation (Step 04). For example, if the touch sensor 10 detects a flick operation as a moving operation from the bottom to the top, the controller 100 drives the window glass to fully close the front side window 250. In addition, if the touch sensor 10 detects a tracing operation, the controller 100 drives the window glass of the front side window 250 in a closing direction according to a traveling amount of the finger in the tracking operation. The controller 100 returns to Step 01 after it has driven the window glass of the front side window 250 in the closing direction and can execute the operation of the window control device according to the first embodiment repeatedly.

The controller 100 determines whether the third specified operation has been performed based on the results of detection of a moving operation (a tracing operation) by the touch sensor 10 (Step 05). As illustrated in FIG. 5B, the controller 100 determines whether a moving operation (a tracing operation) by the finger 400 has been performed on the sensor modules on the rear side (C direction) of the touch sensor 10 in the downward direction. If the controller 100 determines that the third specified operation has been performed, the controller 100 proceeds to Step 06 (Step 05: Yes), whereas if the controller 100 determines that the third specified operation has not been performed, the controller 100 proceeds to Step 07 (Step 05: No).

The controller 100 drives the second actuator 302 to drive a window glass of a rear side window in an opening direction as a drive mode corresponding to the third specified operation (Step 06). For example, if the touch sensor 10 detects a flick operation as a moving operation from the top to the bottom, the controller 100 drives the window glass to fully open the rear side window. In addition, if the touch sensor 10 detects a tracing operation, the controller 100 drives the window glass of the rear side window in an opening direction according to a traveling amount of the finger in the tracking operation. The controller 100 returns to Step 01 after it has driven the window glass of the rear side window in the opening direction and can execute the operation of the window control device according to the first embodiment repeatedly.

The controller 100 determines whether the fourth specified operation has been performed based on the results of detection of a moving operation (a tracing operation) by the touch sensor 10 (Step 07). As illustrated in FIG. 5B, the controller 100 determines whether a moving operation (a tracing operation) by the finger 400 has been performed on the sensor modules on the rear side (C direction) of the touch sensor 10 in the upward direction. If the controller 100 determines that the fourth specified operation has been performed, the controller 100 proceeds to Step 08 (Step 07: Yes), whereas if the controller 100 determines that the fourth specified operation has not been performed, the controller 100 proceeds to Step 09 (Step 07: No).

The controller 100 drives the second actuator 302 to drive the window glass of the rear side window in a closing direction as a drive mode corresponding to the fourth specified operation (Step 08). For example, if the touch sensor 10 detects a flick operation as a moving operation from the bottom to the top, the controller 100 drives the window glass to fully close the rear side window. In addition, if the touch sensor 10 detects a tracing operation, the controller 100 drives the window glass of the rear side window in the closing direction according to a traveling amount of the finger in the tracking operation. The controller 100 returns to Step 01 after it has driven the window glass of the rear side window in the closing direction and can execute the operation of the window control device according to the first embodiment repeatedly.

The controller 100 determines whether the fifth specified operation has been performed based on the results of detection of a moving operation (a tracing operation) by the touch sensor 10 (Step 09). The controller 100 determines whether a moving operation (a tracing operation) by the finger 400 has been performed on the sensor modules of the touch sensor 10 in the rear direction (C direction) in the overall length directions of the vehicle. If the controller 100 determines that the fifth specified operation has been performed, the controller 100 proceeds to Step 10 (Step 09: Yes), whereas if the controller 100 determines that the fifth specified operation has not been performed, the controller 100 proceeds to Step 11 (Step 09: No).

The controller 100 drives the third actuator 303 to lock the doors as a drive mode corresponding to the fifth specified operation (Step 10). The controller 100 returns to Step 01 after it has finished the door locking operation and can execute the operation of the window control device according to the first embodiment repeatedly.

The controller 100 determines whether the sixth specified operation has been performed based on the results of detection of a moving operation (a tracing operation) by the touch sensor 10 (Step 11). The controller 100 determines whether a moving operation (a tracing operation) by the finger 400 has been performed on the sensor modules of the touch sensor 10 in the front direction (A direction) in the overall length directions of the vehicle. If the controller 100 determines that the sixth specified operation has been performed, the controller 100 proceeds to Step 12 (Step 11: Yes), whereas if the controller 100 determines that the sixth specified operation has not been performed, the controller 100 returns to Step 01 and can execute the operation of the window control device according to the first embodiment repeatedly. (Step 11: No)

The controller 100 drives the third actuator 303 to unlock the doors as a drive mode corresponding to the sixth specified operation (Step 12). The controller 100 returns to Step 01 after it has finished the door unlocking operation and can execute the operation of the window control device according to the first embodiment repeatedly.

The specified operations described above are examples of the drive modes. In the specified operations and drive modes, the allocation of the windows, the driving directions, and the like can be changed and set as required.

### SECOND EMBODIMENT

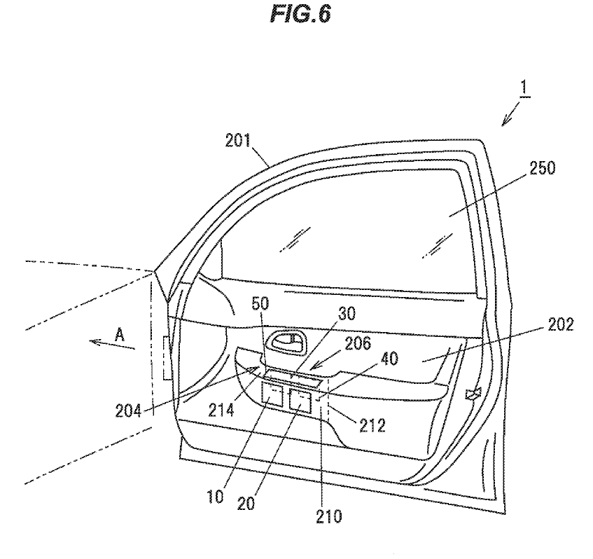

In a second embodiment, as illustrated in FIG. 6, a window control device 1 includes a first touch sensor 10, a second touch sensor 20, a third touch sensor 30, a fourth touch sensor 40, and a fifth touch sensor 50, which are provided on a wall surface of a door pocket which lies on a side closer to a driver seat as sensor sections. The window control device 1 includes the four touch sensors (10, 20, 30, 40) as an example of the number equal to or greater than the number of windows to be opened and closed (a driver seat window, a front passenger seat window, a rear side window on a driver seat side, and a rear side window on a front passenger seat side). In addition, the window control device 1 includes the fifth touch sensor 50 as a sensor, the function of which is not related to the windows, is added to the window control device. In the first touch sensor 10, the second touch sensor 20, the third touch sensor 30, the fourth touch sensor 40, and the fifth touch sensor 50 of this embodiment, N (N is an integer of two or greater) sensor modules may be arranged into N×1 column or (N/2)×2 columns.

As illustrated in FIG. 6, a door trim 202, which is an interior part of a door 201 (a driver seat side door) of a vehicle 200, is provided on a passenger compartment side of the door 201. A door handle 204 is provided on the door trim 202, and this door trim 202 is formed to project toward a driver seat for use by a driver when opening or closing the door. A recess portion or a hole portion, which is large enough for an operator to put in his or her fingers, is provided between the door trim 202 and the door handle 204 as a door pocket 206. For example, the operator opens or closes the door 201 by putting his or her fingers in the door pocket 206 to grip on the door handle 204.

As illustrated in FIG. 6, the first touch sensor 10 and the second touch sensor 20 are provided on an outer wall surface 210 which is a wall surface of the door pocket 206 situated on a side closer to the driver seat. In addition, the third touch sensor 30 and the fourth touch sensor 40 are provided on an inner wall surface 212 of the door trim situated on the passenger compartment side thereof, the inner wall surface 212 facing the outer wall surface 210 across the door handle 204. The first touch sensor 10 and the third touch sensor 30 are disposed on a front side (A direction) of the vehicle, and the second touch sensor 20 and the fourth touch sensor 40 are disposed on a rear side (C direction) of the vehicle.

N (N is an integer of two or greater) sensor modules are arranged in interiors of the first touch sensor 10, the second touch sensor 20, the third touch sensor 30, the fourth touch sensor 40 as described in the first embodiment to detect a moving operation (a tracing operation).

As illustrated in FIG. 6, the fifth touch sensor 50 is disposed on an upper surface 214 of the door handle 204 which is a third surface opened to an interior of the passenger compartment in such a manner as to be contiguous with the outer wall surface 210 of the door pocket 206 situated on the side closer to the driver seat and the inner wall surface 212 of the door trim 202 situated on the passenger compartment side thereof and facing the outer wall surface 210 across the door handle 204.

The fifth touch sensor 50 can detect a moving operation (a tracing operation) in overall length directions of the vehicle.

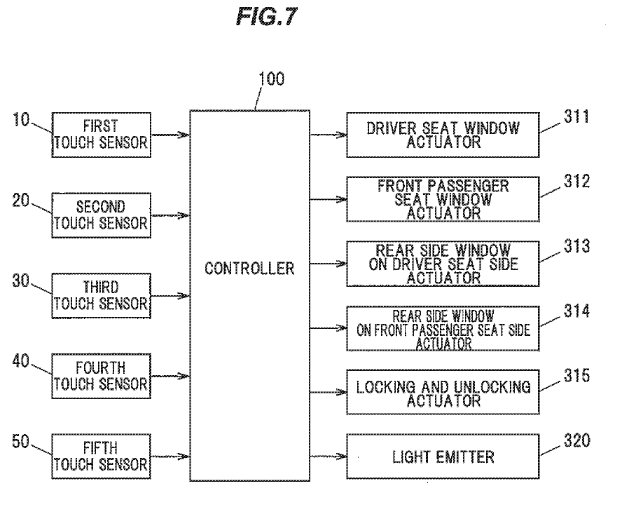

As shown in FIG. 7, in the window control device 1 according to the second embodiment, the first touch sensor 10, the second touch sensor 20, the third touch sensor 30, the fourth touch sensor 40, and the fifth touch sensor 50 are connected to a controller 100. A driver seat window actuator 311, a front passenger seat window actuator 312, a rear side window on a driver seat side actuator 313, a rear side window on a front passenger seat side actuator 314, and a locking and unlocking actuator 315, for window regulators for window control, are connected to the controller 100. In addition, a light emitter 320 is connected to the controller 100 as a unit configured to control the brightness of on-board illuminations mounted on the vehicle (a luminous intensity control). The other configurations of the second embodiment are similar to those of the first embodiment; and thus, the descriptions thereof will be omitted here.

### (Operations of Window Control Device of Second Embodiment)

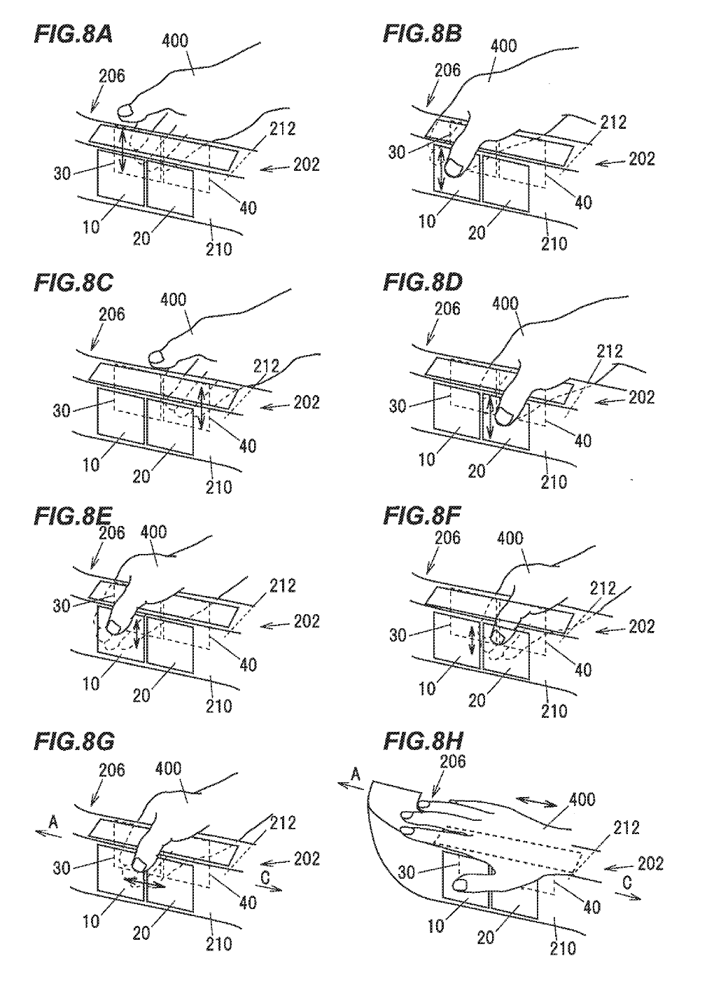

FIGS. 8A to 8H are perspective views illustrating operation examples of the driver seat window, the front passenger seat window, the rear side window on the driver seat side, and the rear side window on the front passenger seat side in the window control device according to the second embodiment. Hereinafter, the operations of the window control device according to the second embodiment will be described based on FIGS. 8A to 8H.

The controller 100 acquires signals from the first touch sensor 10, the second touch sensor 20, the third touch sensor 30, and the fourth touch sensor 40, which are arranged as illustrated in FIG. 6 and FIG. 7, and detects the directions of moving operations (tracing operations) performed on the individual touch sensors by the operator.

For example, in FIG. 8A, when the third touch sensor 30 disposed on the front side on the inner wall surface 212 detects a specified operation which is a moving operation (a tracing operation) performed in a downward direction, the controller 100 drives the driver seat window actuator 311 to drive a window glass of the driver seat window in an opening direction as a drive mode corresponding to the specified operation. When the tracing operation is detected as the moving operation in the way described above, the controller 100 may drive the window glass of the driver seat window in a window opening direction according to a traveling amount of the finger in the tracing operation. When the third touch sensor 30 detects a flick operation as a moving operation performed from a top to a bottom, the controller 100 may drive the window glass to fully open the driver seat window. In addition, when the third touch sensor 30 detects a specified operation which is a moving operation (a tracing operation) performed in an upward direction, the controller 100 drives the driver seat window actuator 311 to drive the window glass of the driver seat window in a closing direction as a drive mode corresponding to the specified operation. When the tracing operation is detected as the moving operation in the way described above, the controller 100 may drive the window glass of the driver seat window in a window closing direction according to a traveling amount of the finger in the tracing operation. When the third touch sensor 30 detects a flick operation as a moving operation performed from the bottom to the top, the controller 100 may drive the window glass to fully close the driver seat window.

In FIG. 8B, when the first touch sensor 10 disposed on the front side on the outer wall surface 210 detects a specified operation which is a moving operation (a tracing operation) performed in a downward direction, the controller 100 drives the front passenger seat window actuator 312 to drive a window glass of the front passenger seat window in an opening direction as a drive mode corresponding to the specified operation. When the tracing operation is detected as the moving operation in the way described above, the controller 100 may drive the window glass of the front passenger seat window in a window opening direction according to a traveling amount of the finger in the tracing operation. When the first touch sensor 10 detects a flick operation as a moving operation performed from a top to a bottom, the controller 100 may drive the window glass to fully open the front passenger seat window. In addition, when the first touch sensor 10 detects a specified operation which is a moving operation (a tracing operation) performed in an upward direction, the controller 100 drives the front passenger seat window actuator 312 to drive the window glass of the front passenger seat window in a closing direction as a drive mode corresponding to the specified operation. When the tracing operation is detected as the moving operation in the way described above, the controller 100 may drive the window glass of the front passenger seat window in a window closing direction according to a traveling amount of the finger in the tracing operation. When the first touch sensor 10 detects a flick operation as a moving operation performed from the bottom to the top, the controller 100 may drive the window glass to fully close the front passenger seat window.

In FIG. 8C, when the fourth touch sensor 40 disposed on the rear side on the inner wall surface 212 detects a specified operation which is a moving operation (a tracing operation) performed in a downward direction, the controller 100 drives the rear side window on the driver seat side actuator 313 to drive a window glass of the rear side window on the driver seat side in an opening direction as a drive mode corresponding to the specified operation. When the tracing operation is detected as the moving operation in the way described above, the controller 100 may drive the window glass of the rear side window on the driver seat side in a window opening direction according to a traveling amount of the finger in the tracing operation. When the fourth touch sensor 40 detects a flick operation as a moving operation performed from a top to a bottom, the controller 100 may drive the window glass to fully open the rear side window on the driver seat side. In addition, when the fourth touch sensor 40 detects a specified operation which is a moving operation (a tracing operation) performed in an upward direction, the controller 100 drives the rear side window on the driver seat side actuator 313 to drive the window glass of the rear side window on the driver seat side in a closing direction as a drive mode corresponding to the specified operation. When the tracing operation is detected as the moving operation in the way described above, the controller 100 may drive the window glass of the rear side window on the driver seat side in a window closing direction according to a traveling amount of the finger in the tracing operation. When the fourth touch sensor 40 detects a flick operation as a moving operation performed from the bottom to the top, the controller 100 may drive the window glass to fully close the rear side window on the driver seat side.

In FIG. 8D, when the second touch sensor 20 disposed on the rear side on the outer wall surface 210 detects a specified operation which is a moving operation (a tracing operation) performed in a downward direction, the controller 100 drives the rear side window on the front passenger seat side actuator 314 to drive a window glass of the rear side window on the front passenger seat side in an opening direction as a drive mode corresponding to the specified operation. When the tracing operation is detected as the moving operation in the way described above, the controller 100 may drive the window glass of the rear side window on the front passenger seat side in a window opening direction according to a traveling amount of the finger in the tracing operation. When the second touch sensor 20 detects a flick operation as a moving operation performed from a top to a bottom, the controller 100 may drive the window glass to fully open the rear side window on the front passenger seat side. In addition, when the second touch sensor 20 detects a specified operation which is a moving operation (a tracing operation) performed in an upward direction, the controller 100 drives the rear side window on the front passenger seat side actuator 314 to drive the window glass of the rear side window on the front passenger seat side in a closing direction as a drive mode corresponding to the specified operation. When the tracing operation is detected as the moving operation in the way described above, the controller 100 may drive the window glass of the rear side window on the front passenger seat side in a window closing direction according to a traveling amount of the finger in the tracing operation. When the second touch sensor 20 detects a flick operation as a moving operation performed from the bottom to the top, the controller 100 may drive the window glass to fully close the rear side window on the front passenger seat side.

In FIG. 8E, when both of the first touch sensor 10 disposed on the front side on the outer wall surface 210 and the third touch sensor 30 disposed on the front side on the inner wall surface 212 detect a specified operation which is a moving operation (a tracing operation) performed in a downward direction, the controller 100 drives the driver seat window actuator 311 and the front passenger seat window actuator 312 to drive panes of window glass of the driver seat window and the front passenger seat window in an opening direction as a drive mode corresponding to the specified operation. In addition, when both of the first touch sensor 10 and the third touch sensor 30 detect a specified operation which is a moving operation (a tracing operation) performed in an upward direction, the controller 100 drives the driver seat window actuator 311 and the front passenger seat window actuator 312 to drive the panes of window glass of the driver seat window and the front passenger seat window in a closing direction as a drive mode corresponding to the specified operation.

In FIG. 8F, when both of the second touch sensor 20 disposed on the rear side on the outer wall surface 210 and the fourth touch sensor 40 disposed on the rear side on the inner wall surface 212 detect a specified operation which is a moving operation (a tracing operation) performed in a downward direction, the controller 100 drives the rear side window on the driver seat side actuator 313 and the rear side window on the passenger seat side actuator 314 to drive panes of window glass of the rear side window on the driver seat side and the rear side window on the passenger seat side in an opening direction as a drive mode corresponding to the specified operation. In addition, when both of the second touch sensor 20 and the fourth touch sensor 40 detect a specified operation which is a moving operation (a tracing operation) performed in an upward direction, the controller 100 drives the rear side window on the driver seat side actuator 313 and the rear side window on the front passenger seat side actuator 314 to drive the panes of window glass of the rear side window on the driver seat side and the rear side window on the front passenger side in a closing direction as a drive mode corresponding to the specified operation.

In FIG. 8G when the first touch sensor 10 to the fourth touch sensor 40 detect a specified operation which is a moving operation (a tracing operation) performed in a rear direction (C direction) in overall length directions of the vehicle, the controller 100 drives the locking and unlocking actuator 315 to lock the doors as a drive mode corresponding to the specified operation. In addition, when the first touch sensor 10 to the fourth touch sensor 40 detect a specified operation which is a moving operation (a tracing operation) performed in a front direction (A direction) in the overall length directions of the vehicle, the controller 100 drives the locking and unlocking actuator 315 to unlock the doors as a drive mode corresponding to the specified operation.

As an example of a specific specified operation, when both of the first touch sensor 10 or the second touch sensor 20 and the third touch sensor 30 or the fourth touch sensor 40 are stroked in the overall length direction of the vehicle as a moving operation (a tracing operation), the controller 100 drives the locking and unlocking actuator 315 to unlock the doors as a drive mode corresponding to the specified operation. The locking and unlocking control can also be applied to other controls than the door control and can be used to lock and unlock the operations of the windows.

In FIG. 8H, when the fifth touch sensor 50 detects a specified operation which is a moving operation (a tracing operation) performed in a rear direction (C direction) in overall length directions of the vehicle, the controller 100 executes a luminous intensity control for increasing the luminous intensity of the light emitter 320 as a drive mode corresponding to the specified operation. In addition, when the fifth touch sensor 50 detects a specified operation which is a moving operation (a tracing operation) performed in a front direction (A direction) in the overall length directions of the vehicle, the controller 100 executes a luminous intensity control for decreasing the luminous intensity of the light emitter 320 as a drive mode corresponding to the specified operation.

The luminous intensity controls by the fifth touch sensor 50 can be omitted. That is, the second embodiment may take a form in which the fifth touch sensor 50 and the luminous intensity controls are omitted.

### Effect of Embodiments

The window control device according to the embodiments have the following advantageous effects.

(1) The window control device 1 according to the embodiments has the number of sensor sections equal to or greater than the number of windows to be opened and closed on the vehicle, the sensor sections having N (N is the integer of two or greater) sensor modules disposed on the door trim of the vehicle, the controller configured to control, when the sensor sections detect the specified operation, which is the operation specified in advance, to control the window that is set according to the specified operation to be driven in the drive mode corresponding to the specified operation. This enables the corresponding windows to be opened and closed in the drive modes corresponding to the individual specified operations. Thus, since the predetermined windows can be opened and closed through a single action, the window control device can be provided which enables the smooth operation in opening and closing the windows.

(2) Since each of the touch sensors is mounted on the pull-handle on the door trim, the driver can access the touch sensors while seated in the driver seat.

(3) The window control device according to the embodiments can be applied not only to the pull-handle having a door pocket but also to a grip type pull-handle.

(4) The window control device according to the embodiments can be applied to any other applications than the opening and closing operations of the windows. and therefore, the window control device can be used, for example, not only to lock and unlock the doors but also to control the luminous intensity of on-board equipment, and moreover, the window control device can be used on an autonomous vehicle.

Thus, while the embodiments of the invention have been described heretofore, these embodiments constitute only the examples, and inventions claimed for patent under claims below are not limited in any way by the embodiments. Such novel embodiments may be implemented in various other forms, and various omissions, substitutions, changes, and the like can be made without departing from the spirit and scope of the present invention. In addition, all of the combinations of the features described in these embodiments are not necessarily needed to solve the technical problem. Further, these embodiments are included within the spirit and scope of the invention and are also included within the scopes of the inventions set forth in claims and equivalents thereof.

### REFERENCE SIGNS LIST

1 Window control device
10 Touch sensor
10a, 10b Sensor section
11, 12, 13, 14, 15, 16, 17, 18 sensor module
100 Controller
200 Vehicle
202 Door trim
204 Door handle
206 Door pocket
210 Outer wall surface
212 Inner wall surface
214 Upper surface
250 Front side window
320 Light emitter

1. A window control device, comprising:
sensor sections, the number of the sensor sections being not less than the number of windows to be opened and closed on a vehicle and the sensor sections having N 3 (wherein N is an integer of two or more) sensor modules disposed on a door trim of the vehicle; and
a controller configured to, when the sensor sections detect a specified operation, which is an operation specified in advance, control a window specified according to the specified operation such that the window is driven in a drive mode corresponding to the specified operation.

2. The window control device according to claim 1, wherein the specified operation is an upward moving operation on the sensor section, and
wherein the drive mode is a drive mode to drive the window in a closing direction thereof.

3. The window control device according to claim 1, wherein the specified operation is a downward moving operation on the sensor section, and
wherein the drive mode is a drive mode to drive the window in an opening direction thereof.

4. The window control device according to claim 2, wherein the specified operation is an upward moving operation by a flick operation on the sensor section, and
wherein the drive mode is a drive mode to drive the window to be fully closed.

5. The window control device according to claim 3, wherein the specified operation is a downward moving operation by a flick operation on the sensor section, and
wherein the drive mode is a drive mode to drive the window to be fully opened.

6. The window control device according to claim 2, wherein the specified operation is an upward moving operation by a tracing operation on the sensor section, and
wherein the drive mode is a drive mode to drive the window in the closing direction by an amount corresponding to an amount of traveling in the tracing operation.

7. The window control device according to claim 3, wherein the specified operation is a downward moving operation by a tracing operation on the sensor section, and
wherein the drive mode is a drive mode to drive the window in the opening direction by an amount corresponding to an amount of traveling in the tracing operation.

8. The window control device according to claim 1, wherein the sensor sections are disposed on a wall surface of a door pocket of the vehicle on a side closer to a driver seat and on a wall surface of the door trim on a vehicle interior side and opposite to the wall surface of the door pocket across a door handle.

9. The window control device according to claim 8, wherein the specified operation is an upward moving operation on both of the sensor sections provided individually on the two wall surfaces, and
wherein the drive mode is a drive mode in the closing direction of both of the windows on a driver seat side and a front passenger seat side.

10. The window control device according to claim 8, wherein the specified operation is a downward moving operation on both of the sensor sections provided individually on the two wall surfaces, and
wherein the drive mode is a drive mode in the opening direction of both of the windows on a driver seat side and a front passenger seat side.

11. The window control device according to claim 8, wherein the specified operation is a moving operation on both of the sensor sections provided individually on the two wall surfaces in an overall length direction of the vehicle, and
wherein the drive mode is a drive mode of locking or unlocking.

12. The window control device according to claim 1, wherein the sensor sections are disposed on a third plane opened toward an interior of the passenger compartment, the third plane being adjacent to a wall surface of a door pocket of the vehicle on a side closer to a driver seat and to a wall surface of the door trim on a vehicle interior side and opposite to the wall surface of the door pocket across a door handle,
wherein the specified operation is a moving operation on the sensor sections in an overall length direction of the vehicle, and
wherein the drive mode is a mode to control an emission of light from a separately provided light emitter.
